(19) United States
(12) Patent Application Publication
(10) Pub. No.: US 2026/0061921 A1
(43) Pub. Date: Mar. 5, 2026

(54) CAR REFRIGERATOR

(71) Applicant: CHILLBEE INC, ROSEMEAD, CA (US)

(72) Inventors: JUN-YU LI, GUANGDONG PROVINCE (CN); XIN-DI LI, ROSEMEAD, CA (US)

(21) Appl. No.: 19/174,352

(22) Filed: Apr. 9, 2025

(30) Foreign Application Priority Data
Sep. 3, 2024 (CN) 202422157213.7

(51) Int. Cl. B60N 3/10

(52) U.S. Cl. CPC B60N 3/104

(57) ABSTRACT

A car refrigerator includes a first container with a first engagement unit, a second container with a second engagement unit, a heat-dissipating device and a refrigeration device. Inlet holes and exhaust holes are respectively formed on the first container. When the first container is installed in a cavity of a car trunk, the first engagement unit and the inlet holes are exposed to a cargo space of the car trunk, whereas the exhaust holes are not communicated with the cargo space. An engagement between the two engagement units facilitates a simplified assembly of the two containers. By operating the heat-dissipating device, air is drawn and flows through the inlet holes, and heat generated by the refrigeration device escapes from the exhaust holes and is forced out of the car trunk, thereby preventing an increase in the temperature of the cargo space and enhancing a heat-dissipation and refrigeration effect.

### BACKGROUND OF THE INVENTION

### 1. Field of the Invention

This invention relates to a refrigerator and relates particularly to a car refrigerator adapted to be installed in a car trunk.

### 2. Description of the Related Art

Recently, with the development of new energy vehicles and the improvement of automotive power supply system, various car appliances adapted to improve driving experience become popular. A car refrigerator, in particular, is convenient and practical in use, and that comes into favor with outdoor enthusiasts. Thus, the car refrigerator gradually becomes one of the essential and important equipment for vehicles. Meanwhile, different car refrigerators keep being rolled out. Some of them are specially designed for specific models of cars. For example, the Tesla Model 3 includes a cavity with a special shape formed on both sides of an interior of its car trunk. The cavity is defined according to the contour of the rear wheel and the interior of the car trunk. Hence, a car refrigerator specially designed based on the shape of the cavity can be installed in the cavity perfectly, thereby making good use of the car trunk and saving space occupied by the car refrigerator.

However, when the car refrigerator is installed in the cavity of the car trunk, both inlet holes and exhaust holes of the car refrigerator are exposed to a cargo space of the car trunk. During an operation of the car refrigerator, the air of the cargo space is drawn by the car refrigerator to flow through the inlet holes for maintaining an operating temperature. The heat generated by the car refrigerator is also expelled to the cargo space through the exhaust holes. The temperature of the drawn air of the cargo space is therefore increased by the expelled heat. The drawn air with the increased temperature results in a slow heat dissipation and affects the operating and refrigeration performance of the car refrigerator. Furthermore, the expelled heat will flow to a front passenger space. Thus, it causes an increase in the temperature of the front passenger space. An air conditioning system adapted to adjust the temperature of the front passenger space should keep operating continuously in order to maintain the temperature stably. It further causes higher energy consumption accordingly, and that requires to be improved.

### SUMMARY OF THE INVENTION

The object of this invention is to provide a car refrigerator designed for a cavity of a car trunk and capable of saving space, expelling heat into an outside, facilitating a quick heat dissipation and a reduction in temperature, and preventing improper energy consumption caused by an increase in the temperature of the car trunk.

The car refrigerator is adapted to be positioned in a car trunk. A cargo space and a cavity are respectively defined by an interior of the car trunk. The cavity has an upper recess and a lower recess communicated with the upper recess. The car refrigerator comprises a first container, a second container engaged with the first container, a heat-dissipating device situated in the first container, and a refrigeration device adapted to lower a temperature of the second container. The first container has a first engagement unit, a plurality of inlet holes, and a plurality of exhaust holes. The second container has a second engagement unit detachably engaged with the first engagement unit. The first container and the second container are fixed together by engaging the first engagement unit with the second engagement unit. When the first container is installed in the lower recess, the first engagement unit and the inlet holes are exposed to the cargo space of the car trunk, thereby facilitating the engagement between the first engagement unit and the second engagement unit to further simplify the assembly of the first container and the second container. Further, the exhaust holes are not communicated with the cargo space. The heat-dissipating device is allowed to draw air of the cargo space and expel heat generated by operating the refrigeration device. The drawn air flows through the inlet holes, and the expelled heat escapes from the exhaust holes for being discharged into an outside, thereby effectively preventing an unduly increase in the temperature of the cargo space, improving a heat-dissipation and refrigeration effect of the car refrigerator, maintaining a smooth operating performance, and reducing the improper energy consumption caused by the unduly increase in the temperature.

Preferably, a first location where the inlet holes are formed is different from a second location where the exhaust holes are formed. The first location of the inlet holes is above the refrigeration device and the second location of the exhaust holes.

Preferably, an opening is formed on the second container. The first container includes a locking unit. The locking unit includes a base disposed on the first container, a locking member protruding outward from the base, and a spring member disposed on the base. The locking member is lodged into the opening of the second container by pushing the locking member outwards with the spring member.

Preferably, the locking unit includes an operating member disposed on the base. The operating member serves to release the locking member from the opening.

Preferably, a partition unit is longitudinally installed in the first container to divide an interior of the first container into a main room and an accommodation room. The main room is communicated with the inlet holes. The accommodation room is communicated with the exhaust holes. The refrigeration device is installed in the accommodation room.

Preferably, the heat-dissipating device is disposed on the partition unit. The heat-dissipating device includes a fan unit situated in the main room and a radiator situated in the accommodation room. A through hole is formed on the partition unit and situated between the radiator and the fan unit.

Preferably, a storage unit is positioned on a partition layer and located inside the second container. The partition layer is disposed between the first container and the second container. The partition layer includes an inclined surface portion. The inclined surface portion is located inside the first container and spaced apart from an inner wall of the first container to form an air channel.

Preferably, the refrigeration device includes a compressor and a condensate pipe unit connected to the compressor. The condensate pipe unit is extended into the second container.

Preferably, the condensate pipe unit is disposed on an inner wall of the second container. The condensate pipe unit has a tortuous shape.

Preferably, the second container includes a door unit and a control panel disposed on the door unit. The door unit is adapted to cover the second container so that the second container is in a closed state.

### BRIEF DESCRIPTION OF THE DRAWINGS

FIG. 1 is a perspective view showing a first preferred embodiment of this invention;

FIG. 2 is an exploded view showing the first preferred embodiment of this invention;

FIG. 3 is a schematic view showing the assembly of the first container and the second container;

FIG. 4 is a schematic view showing the bottom of the first container and the second container;

FIG. 5 is a schematic view showing the locking unit;

FIG. 6 is an exploded view showing the first preferred embodiment of this invention;

FIG. 7 is a cross-sectional view showing the first preferred embodiment of this invention;

FIG. 8 is a schematic view showing the car trunk; and

FIG. 9 is a schematic view showing that the car refrigerator is installed in the car trunk.

### DETAILED DESCRIPTION OF THE PREFERRED EMBODIMENTS

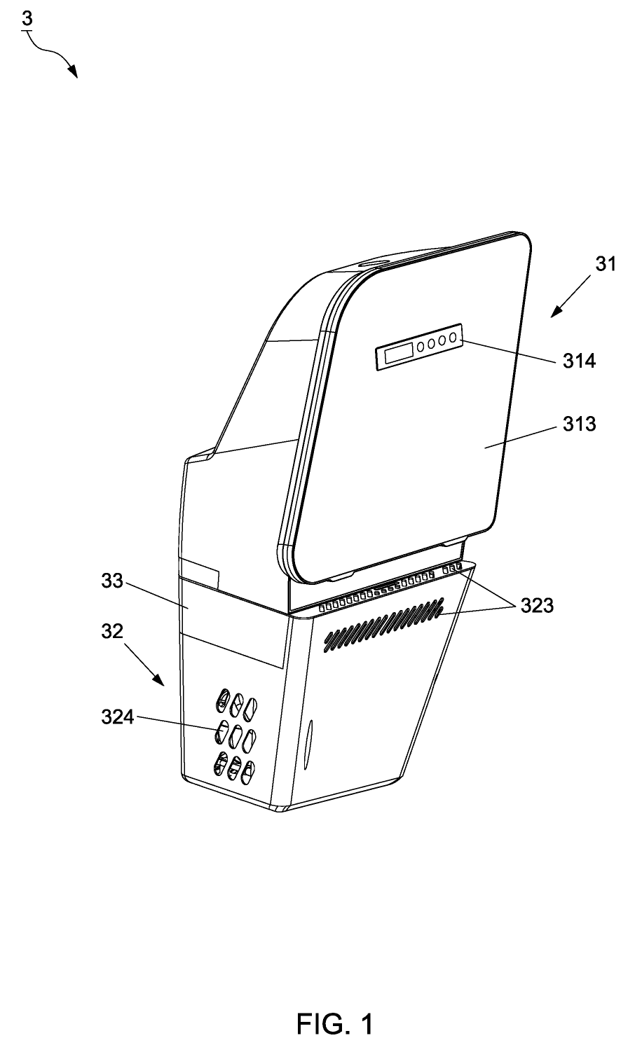

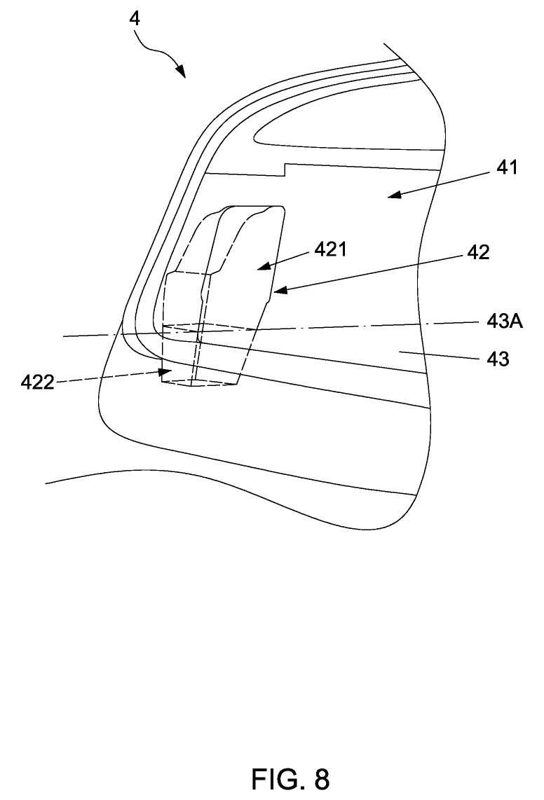

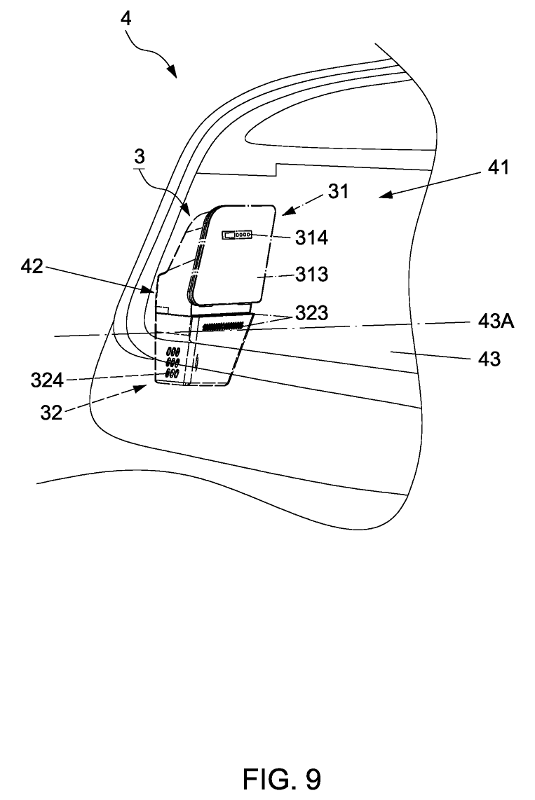

Referring to FIGS. 1, 2, 8 and 9, a first preferred embodiment of a car refrigerator 3 of this invention is disclosed. The car refrigerator 3 is adapted to be mounted in a car trunk 4. An interior of the car trunk 4 defines a cargo space 41, two cavities 42 communicated with the cargo space 41, and a floor 43 located between the cavities 42. In FIGS. 8 and 9, only one cavity 42 of the cargo trunk 4 is shown. A baseline 43A is defined by the floor 43. Each cavity 42 has an upper recess 421 and a lower recess 422 communicated with the upper recess 421. The upper recess 421 is located above the baseline 43A and exposed to the cargo space 41 of the car trunk 4. The lower recess 422 is located below the baseline 43A. Namely, the lower recess 422 is hidden and recessed below the floor 43 of the car trunk 4. The shape of the car refrigerator 3 is identical to the shape of the cavity 42, and thus the car refrigerator 3 is capable of being fitted in the cavity 42 perfectly.

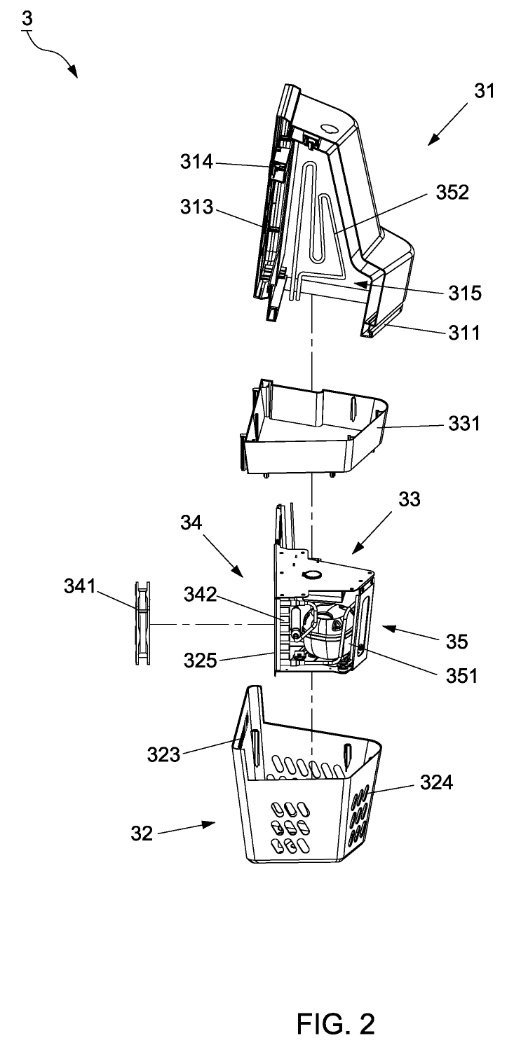

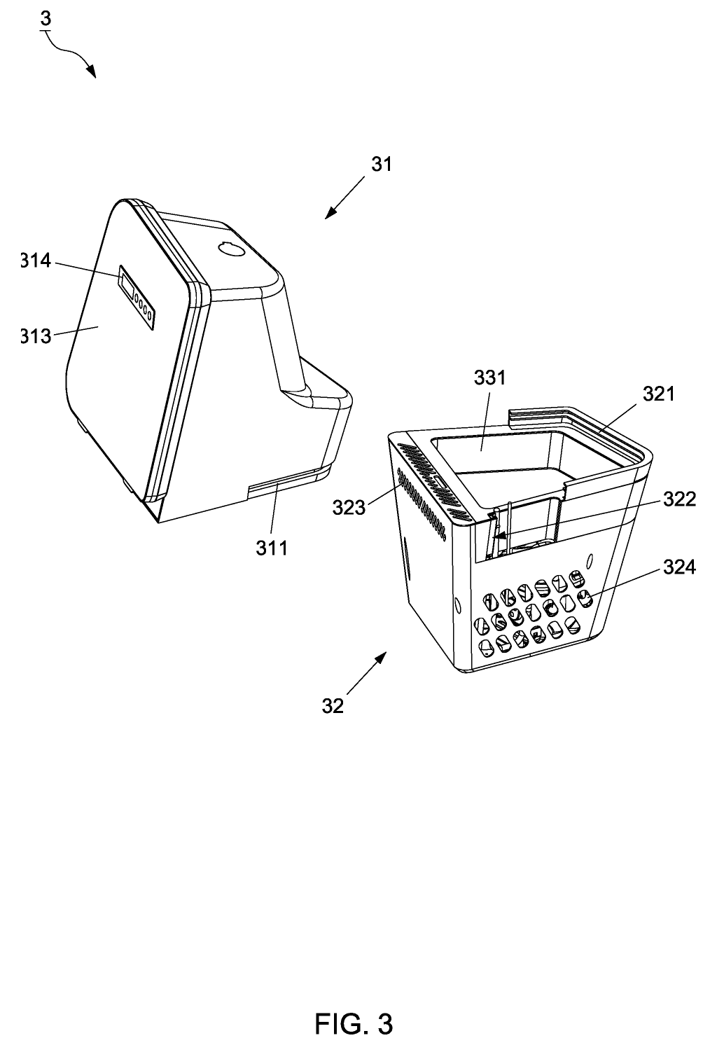

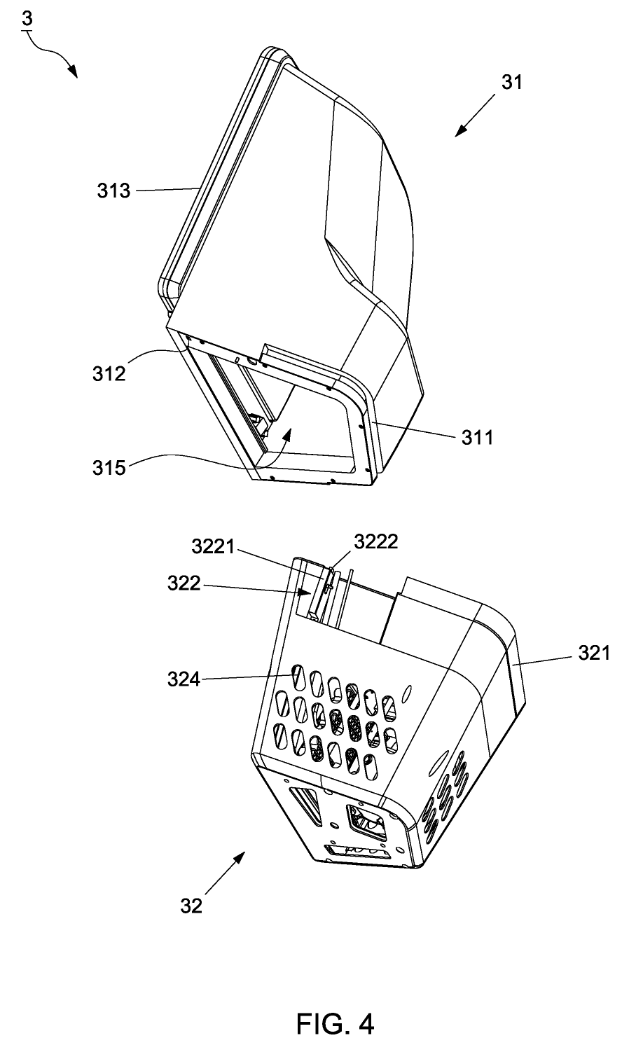

Referring to FIGS. 2, 3, 4 and 9, the car refrigerator 3 includes a second container 31, a first container 32 relative to the second container 31, a partition layer 33 located between the first container 32 and the second container 31, a heat-dissipating device 34 installed in the first container 32, and a refrigeration device 35 adapted to reduce a temperature of the second container 31. Referring to FIGS. 3 and 4, the second container 31 has a second engagement unit 311, an opening 312, a door unit 313, a control panel 314 installed on the door unit 313, and a storage space 315 formed inside the second container 31. In this preferred embodiment, the control panel 314 is adapted to control the car refrigerator 3 and display the information of the car refrigerator 3, thereby adjusting a temperature of the storage space 315 of the second container 31, executing a lock action or an unlock action of the door unit 313, and proceeding the maintenance of the car refrigerator 3 according to the displayed information. Further, a handle (not shown) can be installed on the door unit 313 according to needs.

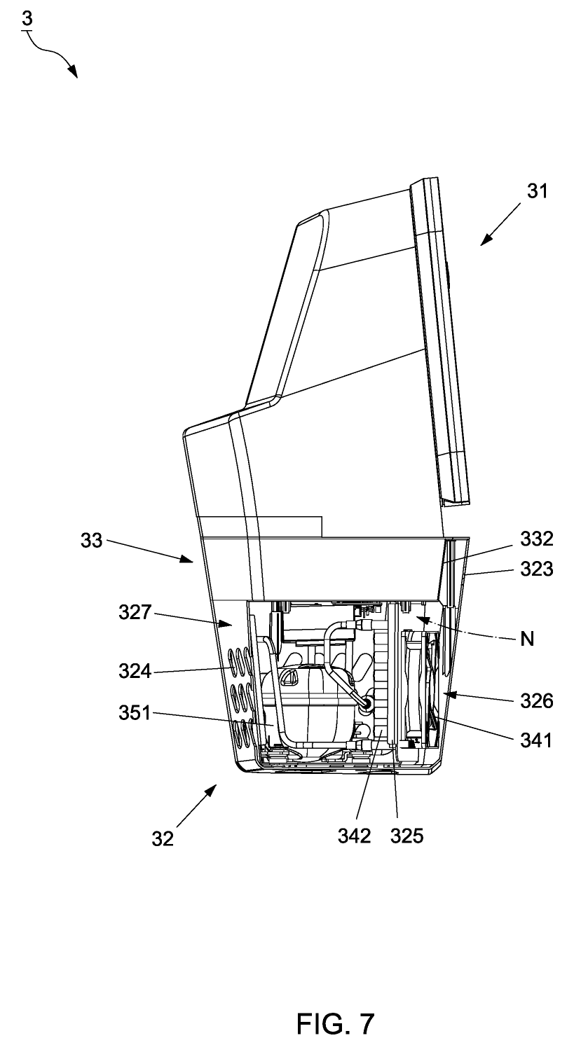

Referring to FIGS. 2 and 7, a storage unit 331 is positioned on the partition layer 33. When the storage unit 331 is situated on the partition layer 33, the storage unit 331 is located in the storage space 315 of the second container 31 so that foods or drinks can be placed on the storage unit 331 and refrigerated in the second container 31. Meanwhile, the storage unit 331 can be detached from the partition layer 33, thereby facilitating a cleaning and maintenance operation. The partition layer 33 has an inclined surface portion 332 situated in the first container 32 and spaced apart from an inner wall of the first container 32 to form an air channel N. Further, the refrigeration device 35 has a compressor 351 installed in the first container 32 and a condensate pipe unit 352 connected to the compressor 351. The condensate pipe unit 352 is extended into the storage space 315 of the second container 31 and disposed on an inner wall of the second container 31. The condensate pipe unit 352 is arranged in a tortuous shape. The refrigeration device 35 is adapted to reduce a temperature of the storage space 315 of the second container 31 so that the second container 31 can be used for cooling foods and drinks.

Referring to FIGS. 2, 3, 4 and 7, the first container 32 has a first engagement unit 321 relative to the second engagement unit 311, a locking unit 322 relative to the opening 312, a plurality of inlet holes 323, a plurality of exhaust holes 324, and a partition unit 325 longitudinally installed in the first container 32. The first engagement unit 321 is detachably engaged with the second engagement unit 311. A through hole 3251 is formed on the partition unit 325. The first container 32 is divided into a main room 326 communicated with the inlet holes 323 and an accommodation room 327 communicated with the exhaust holes 324 when the partition unit 325 is situated in the first container 32. The compressor 351 of the refrigeration device 35 is installed in the accommodation room 327. Referring to FIG. 9, the inlet holes 323 are formed at a first location and the exhaust holes 324 are formed at a second location. The first location of the inlet holes 323 is different from the second location of the exhaust holes 324. The first location is located above the refrigeration device 35 and above the second location of the exhaust holes 324. In this preferred embodiment, the first location of the inlet holes 323 is adjacent to the top of the main room 326. The inlet holes 323 are arranged in more than one row. The second location of the exhaust holes 324 is adjacent to an outer periphery of the accommodation room 327. Thus, an air flow area is enlarged effectively so that the air of the cargo space 41 is drawn to flow through the inlet holes 323 quickly and the heat generated by operating the refrigeration device 35 is expelled to flow through the exhaust holes 324 quickly into the outside.

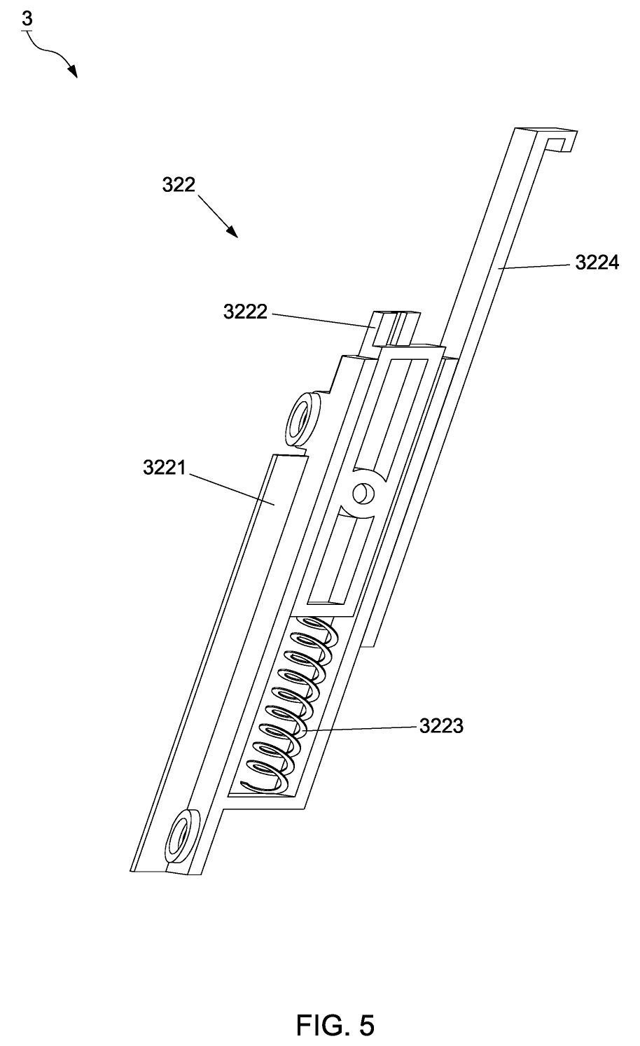

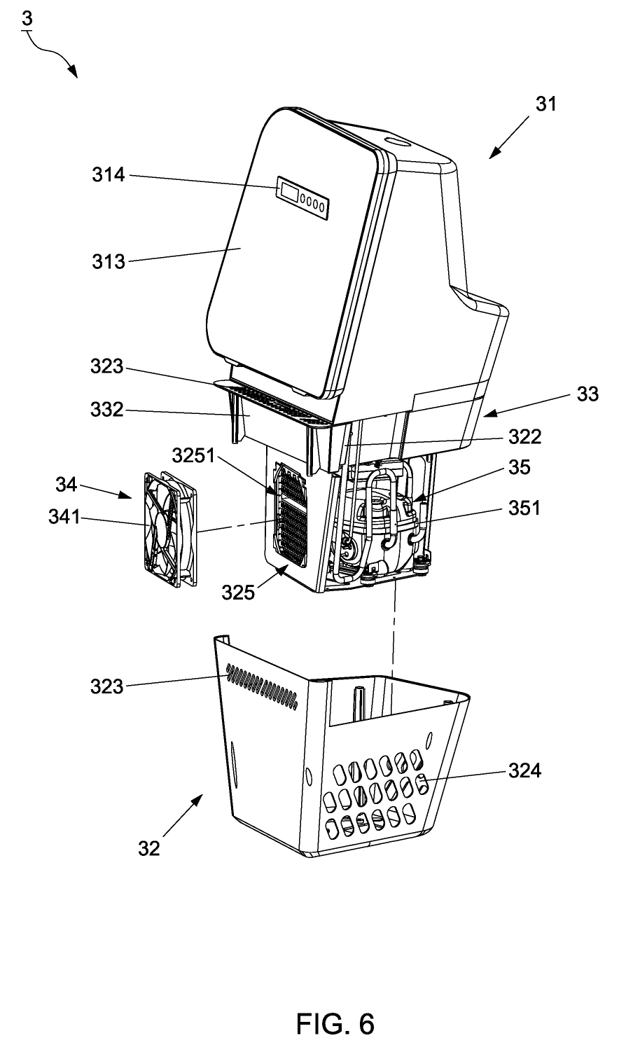

Referring to FIGS. 5, 6 and 7, the heat-dissipating device 34 is installed on the partition unit 325. The heat-dissipating device 34 has a fan unit 341 situated in the main room 326 and a radiator 342 situated in the accommodation room 327. The through hole 3251 is situated between the radiator 342 and the fan unit 341. The radiator 342 is adapted to absorb the heat generated by operating the compressor 351, and the fan unit 341 is adapted to draw the air of the cargo space 41 for reducing a temperature of the radiator 342. Referring to FIG. 5, the locking unit 322 has a base 3221 installed on the first container 32, a locking member 3222 extended outward from the base 3221, a spring member 3223 installed on the base 3221 and connected to the locking member 3222, and an operating member 3224 installed on the base 3221. The locking member 3222 is lodged into the opening 312 of the second container 31 by pushing the locking member 3222 outwards with the spring member 3223.

Referring to FIGS. 5, 6 and 9, when the car refrigerator 3 is positioned in the cavity 42, the first container 32 is situated in the lower recess 422 and the second container 31 is situated in the upper recess 421. Meanwhile, the first engagement unit 321 and the inlet holes 323 are located above the baseline 43A of the floor 43. Namely, the first engagement unit 321 is exposed to the cargo space 41 of the car trunk 4 whereby the second engagement unit 311 can be engaged with or detached from the first engagement unit 321 easily to further simplify the assembly and the disassembly of the second container 31 and the first container 32. The inlet holes 323 are also exposed to the cargo space 41 of the car trunk 4, and thus the first container 32 is communicated with the cargo space 41 through the inlet holes 323, thereby allowing the drawn air to pass through the inlet holes 323 smoothly and quickly. Besides, the exhaust holes 324 are located below the baseline 43A of the floor 43. Namely, the exhaust holes 324 are not exposed to and not communicated with the cargo space 41, thereby preventing the expelled heat from flowing back to the cargo space 41 when the expelled heat is discharged outwards through the exhaust holes 324. The exhaust holes 324 are communicated with the outside through an exterior body shell or a frame of the car trunk 4. Or, additional holes (not shown) are made through the lower recess 422 to allow the exhaust holes 324 to be communicated with the outside through the holes, thereby ensuring that the expelled heat flows to the outside consequentially. Further, the operating member 3224 of the locking unit 322 is located above the baseline 43A of the floor 43, thereby increasing the convenience in operating the operating member 3224. Thus, the spring member 3223 is pressed by operating the operating member 3224 whereby the spring member 3223 stops pushing the locking member 3222. The locking member 3222 is thus retreated from the opening 312 to thereby release the locking member 3222 from the opening 312.

Referring to FIGS. 3, 5, 6 and 9, in this preferred embodiment, the first engagement unit 321 is disposed on the top of the first container 32. The second engagement unit 311 is disposed on the bottom of the second container 31. The shape of the first engagement unit 321 is relative to the shape of the second engagement unit 311, thereby achieving a tight engagement between the first engagement unit 321 and the second engagement unit 311. During an installation of the car refrigerator 3, the first container 32 is situated in the lower recess 422 first. The first engagement unit 321 and the inlet holes 323 of the first container 32 are located above the baseline 43A of the floor 43 and exposed to the cargo space 41 of the car trunk 4. After that, the second container 31 is positioned above the first container 32 to allow the second engagement unit 311 to be engaged with the first engagement unit 321. Meanwhile, the locking member 3222 of the locking unit 322 is pushed by the spring member 3223 and inserted into the opening 312 of the second container 31 when the locking unit 322 is located at a position relative to the opening 312 so that the first container 32 and the second container 31 are fixed together tightly. The first container 32 is situated in the upper recess 421 duly. Thus, the car refrigerator 3 is installed and fitted in the cavity 42 perfectly. The second container 31 is then opened by operating the door unit 313 so that foods and drinks which are prepared for being refrigerated can be put on the storage unit 331. The foods and drinks are located in the storage space 315 of the second container 31. Because the second container 31 is located above the baseline 43A of the floor 43, it is convenient for putting the foods and drinks into the second container 31. After the foods and drinks are positioned duly, the door unit 313 is adapted to cover the second container 31 so that the second container 31 is in a closed state. Afterward the control panel 314 is adapted to adjust the temperature of the storage space 315 of the second container 31. The refrigeration device 35 is driven to lower the temperature of the storage space 315 and cool the foods and drinks in the second container 31. At the same time, the partition layer 33 is capable of preventing the heat generated by operating the compressor 351 of the refrigeration device 35 from entering into the second container 31, thereby improving the refrigeration effect effectively. The partition layer 33 is also capable of supporting the bottom of the second container 31.

The heat generated by operating the compressor 351 is absorbed by the radiator 342. The fan unit 341 then draws the air of the cargo space 41 of the car trunk 4. The drawn air passes through the inlet holes 323 and enters into the first container 32. Because the inclined surface portion 332 of the partition layer 33 helps enlarge the air channel N gradually, the drawn air enters into the main room 326 from the air channel N smoothly and passes the radiator 342 from the through hole 3251 of the partition unit 325 to thereby reduce the temperature of the radiator 342. The heat is carried and expelled outwards by the drawn air. The expelled heat passes through the exhaust holes 324 into the outside to form a one-way channel, thereby dissipating the heat quickly, increasing the heat-dissipation and refrigeration effect, maintaining the operating performance of the car refrigerator 3 smoothly, preventing the heat from flowing back to the cargo space 41 of the car trunk 4, and reducing the energy consumption caused by the increasing temperature of the cargo space 41 of the car trunk 4.

When removing the second container 31 from the first container 32, the operating member 3224 is adapted to detach the second container 31 from the first container 32. Because the operating member 3224 is located above the baseline 43A of the floor 43 and exposed to the cargo space 41 of the car trunk 4, the operating member 3224 is easy to reach and operate. By operating the operating member 3224, the spring member 3223 is pressed to thereby stop pushing the locking member 3222. Thus, the locking member 3222 is retracted from the opening 312 to thereby release the engagement between the second container 31 and the first container 32.

To sum up, the car refrigerator of this invention takes advantages that the first engagement unit and the inlet holes are exposed to the cargo space of the car trunk when the first container is positioned duly so that the second container and the first container are engaged by the cooperation of the second engagement unit and the first engagement unit, thereby facilitating the quick and convenient assembly. Meanwhile, the heat-dissipating device is adapted to draw the air of the cargo space and expel the heat generated by operating the refrigeration device. The drawn air flows through the inlet holes and the expelled heat flows through the exhaust holes into the outside, thereby preventing the temperature of the cargo space of the car trunk from being increased unduly, reducing the energy consumption, and maintaining the heat-dissipation and refrigeration effect of the car refrigerator.

While the embodiments of this invention are shown and described, it is understood that further variations and modifications may be made without departing from the scope of this invention.

What is claimed is:

1. A car refrigerator adapted to be installed in a car trunk, an interior of said car trunk defining a cargo space and a cavity, with said cavity including an upper recess and a lower recess communicated with said upper recess, said car refrigerator comprising:
a first container situated in said lower recess;
a second container situated in said upper recess;
a heat-dissipating device installed in said first container; and
a refrigeration device aimed at reducing a temperature of said second container; wherein a first engagement unit is disposed on said first container, and a second engagement unit is disposed on said second container, said second engagement unit being detachably engaged with said first engagement unit, said first container and said second container being fixed together by engaging said first engagement unit with said second engagement unit, a plurality of inlet holes and a plurality of exhaust holes being respectively formed on said first container; and
wherein when said first container is disposed in said lower recess, said first engagement unit and said plurality of inlet holes are exposed to said cargo space of said car trunk, whereas said plurality of exhaust holes are not exposed to said cargo space of said car trunk, said heat-dissipating device thereby being allowed to draw air of said cargo space and expel heat generated by operating said refrigeration device, said drawn air flowing through said plurality of inlet holes, and said expelled heat escaping from said plurality of exhaust holes for being discharged into an outside, thereby facilitating a quick heat dissipation and a reduction in temperature.

2. The car refrigerator according to claim 1, wherein a first location where said plurality of inlet holes are formed is different from a second location where said plurality of exhaust holes are formed, said first location of said plurality of inlet holes being above said refrigeration device and said second location of said plurality of exhaust holes.

3. The car refrigerator according to claim 1, wherein an opening is formed on said second container, said first container including a locking unit, with said locking unit including a base disposed on said first container, a locking member protruding outward from said base, and a spring member disposed on said base, said locking member being lodged into said opening of said second container by pushing said locking member outwards with said spring member.

4. The car refrigerator according to claim 3, wherein said locking unit includes an operating member disposed on said base, said operating member serving to release said locking member from said opening.

5. The car refrigerator according to claim 1, wherein a partition unit is longitudinally installed in said first container to divide an interior of said first container into a main room and an accommodation room, said main room being communicated with said plurality of inlet holes, said accommodation room being communicated with said plurality of exhaust holes, said refrigeration device being installed in said accommodation room.

6. The car refrigerator according to claim 5, wherein said heat-dissipating device is disposed on said partition unit, said heat-dissipating device including a fan unit situated in said main room and a radiator situated in said accommodation room, a through hole being formed on said partition unit and situated between said radiator and said fan unit.

7. The car refrigerator according to claim 1, further comprising a storage unit, said storage unit being positioned on a partition layer and located inside said second container, with said partition layer disposed between said first container and said second container, said partition layer including an inclined surface portion, said inclined surface portion being located inside said first container and spaced apart from an inner wall of said first container to form an air channel.

8. The car refrigerator according to claim 1, wherein said refrigeration device includes a compressor and a condensate pipe unit connected to said compressor, said condensate pipe unit being extended into said second container.

9. The car refrigerator according to claim 8, wherein said condensate pipe unit is disposed on an inner wall of said second container, said condensate pipe unit having a tortuous shape.

10. The car refrigerator according to claim 1, wherein said second container includes a door unit and a control panel disposed on said door unit, said door unit being adapted to cover said second container so that said second container is in a closed state.
